(19) United States
(12) Patent Application Publication
(10) Pub. No.: US 2025/0055225 A1
(43) Pub. Date: Feb. 13, 2025

(54) PLUG SYSTEM FOR SEWER INSPECTION SYSTEMS AND/OR SEWER MAINTENANCE SYSTEMS

(71) Applicant: iPEK International GmbH, Sulzberg (DE)

(72) Inventors: Gerhard Kennerknecht, Oberstorf-Tiefenbach (DE); Daniel Muenzer, Sulzberg (DE)

(21) Appl. No.: 18/735,707

(22) Filed: Jun. 6, 2024

(30) Foreign Application Priority Data
Jun. 6, 2023 (EP) 23177628.7

(51) Int. Cl. H01R 13/639; G01N 21/954; H01R 13/52; H04B 10/114

(52) U.S. Cl. CPC H01R 13/639; H01R 13/5219; G01N 21/954; H01R 2201/20; H04B 10/1143

(57) ABSTRACT

A connector unit is provided for a component of a sewer inspection and/or maintenance system, wherein the connector unit comprises:
an energy transmission device for transmitting electrical energy between the connector unit and another connector unit, and
a signal transmitting and/or signal receiving device which is designed to wirelessly transmit data between the connector unit and the additional connector unit,
   wherein the connector unit can be detachably coupled to the additional connector unit.

### CROSS-REFERENCE TO RELATED APPLICATIONS

This application claims priority to European Patent Application Serial No. EP23177628.7, filed Jun. 6, 2023, the entire disclosure of which is hereby incorporated herein by reference in its entirety.

### FIELD OF THE INVENTION

The invention relates to a connector unit for a component of a sewer inspection and/or maintenance system, and a device for coupling two connector units.

### BACKGROUND OF THE INVENTION

It is known to use sewer inspection or maintenance systems to carry out pipe or sewer inspections and maintenance work in sewer systems. Such sewer inspection or maintenance systems usually have a control unit that can be used outside the sewer but also in the sewer to control the particular sewer inspection or maintenance system and/or to receive data, such as video data, from the particular sewer inspection or maintenance system. The connection between the control unit and the sewer inspection or maintenance system can be wired or wireless.

In such sewer inspection and/or maintenance systems, during use, several components are usually combined with one another such as a trolley on which additional components, such as a light or a camera, are arranged. Conventional multi-pin connectors are currently used for arranging such additional components.

Connectors or connector systems in sewer inspection and/or maintenance systems are subject to extremely difficult environmental influences in the sewer system, particularly with regard to moisture and dirt. Accordingly, there are high safety requirements for such connectors or connector systems. The connectors must also meet requirements with regard to safety and explosion protection. In this respect, the connectors that are adapted for components of a sewer inspection and/or maintenance system according to the conventional concept require very time-consuming, complex, and costly production despite their supposedly simple design.

### OBJECT OF THE INVENTION

The object of the present invention is therefore to provide a connector or a connector unit and a device for coupling two connector units for use in sewer systems, which are easier to manufacture, require less maintenance, are less sensitive to contamination, and are easier to handle.

### SUMMARY OF THE INVENTION

According to the invention, this object is achieved by the connector unit according to independent claim 1 and the associated device according to claim 10. Advantageous embodiments and additional developments of the invention are specified in the particular dependent claims.

Accordingly, a connector unit is provided for a component of a sewer, inspection and/or maintenance system, wherein the connector unit comprises:
an energy transmission device for transmitting electrical energy between the connector unit and an additional connector unit, and
a signal transmitting and/or signal receiving device which is designed to wirelessly transmit data between the connector unit and the additional connector unit,
   wherein the connector unit can be detachably coupled to the additional connector unit.

The configuration of the signal transmission between the connector unit and an additional connector unit as wireless signal transmission has the advantage that fewer contacts have to be provided on the connector unit. Accordingly, all that is required are the contacts for energy transmission or power supply, although these contacts can also be dispensed with in the case of wireless energy transmission. This means that the number of poles can be reduced to a maximum of two- or even to zero in the case of inductive energy transmission. In this respect, the connector unit according to the invention is mechanically less complex to manufacture since fewer or no contact pins have to be provided. In addition, maintenance of the connector unit is simplified.

The connector unit according to the invention is also subject to low wear and has a longer life expectancy than previously known plug connectors due to the smaller number of poles required. In addition, the high safety requirements and standards with regard to fire protection, electromagnetic compatibility and explosion protection can be more easily met or implemented with the connector unit according to the invention.

The bandwidth of the wireless data transmission between the connector unit and the other connector unit can be dimensioned such that video data, in particular high-resolution video data, can also be transmitted. In addition, different transmission paths can be provided for video data and control or sensor data.

A significant advantage of the invention is that measures for explosion protection which are absolutely necessary in the field of sewer inspection and/or maintenance can be partially or completely dispensed with. In any case, the effort for explosion protection measures can be significantly reduced which considerably simplifies production and maintenance.

It can be provided that the energy transmission device comprises at least two contact-making sockets. Furthermore, it can be provided that the energy transmission device comprises at least two contact-making pins.

According to these embodiments, the connector unit has (optionally) either two contact-making sockets or two contact-making pins, each of which corresponds to an (optional) socket of an additional connector unit.

The energy transmission device can comprise a module that is adapted to transmit the electrical energy between the connector unit and the additional connector unit on an inductive basis.

According to this aspect of the invention, the connector unit can be designed without contact-making pins or contact-making sockets so that the interface of the connector unit can be designed, for example, as a flat surface. This design considerably simplifies the design, manufacture and production of the connector units, in particular since fewer mechanical tolerances have to be observed. In addition, the life expectancy of the connector unit is further increased by this design, since the energy transmission device and the signal transmitting and/or signal receiving device are exposed to virtually no mechanical stress.

Furthermore, the connector unit can also be designed pressure-tight and waterproof.

It can be advantageous if the connector unit is rotationally symmetrical about its longitudinal axis.

The rotationally symmetrical design of the connector unit has the advantage that the connector unit can be coupled to the other connector unit in any position. For this purpose, the energy transmission device and the signal transmitting and/or signal receiving device must also be designed rotationally symmetrical. Such a design of the connector unit therefore simplifies its handling during operation and promotes the longevity of the connector unit. With rotationally symmetrical connector units, complex and vulnerable sliding contacts can also be dispensed with. It also allows for quick and easy plugging without prior alignment of an anti-twist device.

Alternatively, the connector unit can be designed such that it has a preferred direction for coupling to an additional connector unit. This can simplify the arrangement and construction of the energy transmission device as well as the signal transmitting and/or signal receiving device.

It can be advantageous if the signal transmitting and/or signal receiving device comprises a first signal receiver and/or transmitter, wherein the first signal receiver and/or transmitter is adapted to wirelessly transmit high-resolution image data, sensor data and/or control data between the connector unit and the additional connector unit.

Furthermore, it can be advantageous if the signal transmitting and/or signal receiving device comprises a second signal receiver and/or transmitter, wherein the second signal receiver and/or transmitter is adapted to wirelessly transmit image data, sensor data and/or control data between the connector unit and the additional connector unit.

The first signal receiver and/or transmitter is therefore adapted to transmit high-resolution image data and/or control data via a wireless communication connection between the connector unit and the additional connector unit. This includes receiving high-resolution image data and/or control data and sending same. Near-field radio standards known per se can be used for this purpose.

In one embodiment of the invention, the wireless energy transmission between two connector units can be carried out by means of inductive coupling. In one embodiment of the invention, the wireless transmission of data between two connector units can be carried out by means of capacitive coupling.

A first wireless communication connection can be established between the first signal receiver and/or transmitter of the connector unit and the particular signal receiver and/or transmitter of the additional connector unit. A second wireless communication connection can be established between the second signal receiver and/or transmitter and the particular signal receiver and/or transmitter of the additional connector unit. The two wireless communication connections can differ in particular in their bandwidth, since a higher bandwidth is required for the transmission of high-resolution image data than for the transmission of control data.

The connector unit can comprise a housing. A locking device can be arranged on the housing of the connector unit.

The housing ensures protection for the interface of the connector unit from dust and moisture. By means of the locking device, the connector unit coupled to the other connector unit can be prevented from inadvertently disconnecting during operation. This embodiment is in particular advantageous for connecting additional movable components, such as a lift to a trolley or a cable drum.

Furthermore, a device is provided for coupling two components of a sewer cleaning and/or maintenance system, wherein the device comprises a first connector unit mentioned above and a second connector unit mentioned above, wherein the two connector units can be detachably coupled to one another, wherein the coupling of the two connector units comprise:
at least one wireless communication connection between the signal transmitting and/or signal receiving device of the first connector unit (10) and the signal transmitting and/or signal receiving device of the second connector unit, and
an energy transmission between the energy transmission device of the first connector unit and the energy transmission device of the second connector unit.

The device or connector system inherits the above-described advantages of the individual connector unit so that the device enables a low-maintenance, easy-to-design and easy-to-manufacture connection of additional components in sewer inspection and/or maintenance systems. In addition, the device complies with standardized safety requirements.

The at least one wireless communication connection can be designed as a bidirectional communication connection.

Due to the at least one bidirectional communication connection, the interface of a connector unit can be designed mirror-symmetrical to the interface of an additional connector unit. This means that each connector unit can be designed with the same signal transmitting and/or signal receiving device, regardless of whether it is used to send or receive data. In this embodiment, the signal transmitting and/or signal receiving device should be able to both transmit and receive.

This embodiment can additionally simplify the design and manufacture of the connector units for the device according to the invention.

It can be advantageous if, in the coupling of the two connector units, the particular energy transmission devices and signal transmitting and/or signal receiving devices are substantially sealed gas- and fluid-tight against the environment.

With this design, the interface of the device is protected against dust and splash water from the typical sewer environment. The seal can be designed, for example, by means of a radial, circumferential seal on the first (or second) connector unit, wherein the second (or first) connector unit is pressed against the seal by a corresponding locking device.

The above-mentioned wireless communication connections can be designed as optical communication connections.

### BRIEF DESCRIPTION OF THE DRAWINGS

Further details and features of the inventions as well as specific, in particular advantageous, embodiments of the invention are apparent from the following description in conjunction with the drawings, in which:

FIG. 1 shows a side view of a connector unit coupled to an additional connector unit according to a first aspect of the invention;

FIG. 2 shows a side view of a connector unit coupled to an additional connector unit according to a second aspect of the invention; and

FIG. 3 shows a side view of a connector unit coupled to an additional connector unit according to a third aspect of the invention, as well as a sectional plane A-A through the connector unit.

### DETAILED DESCRIPTION OF THE INVENTION

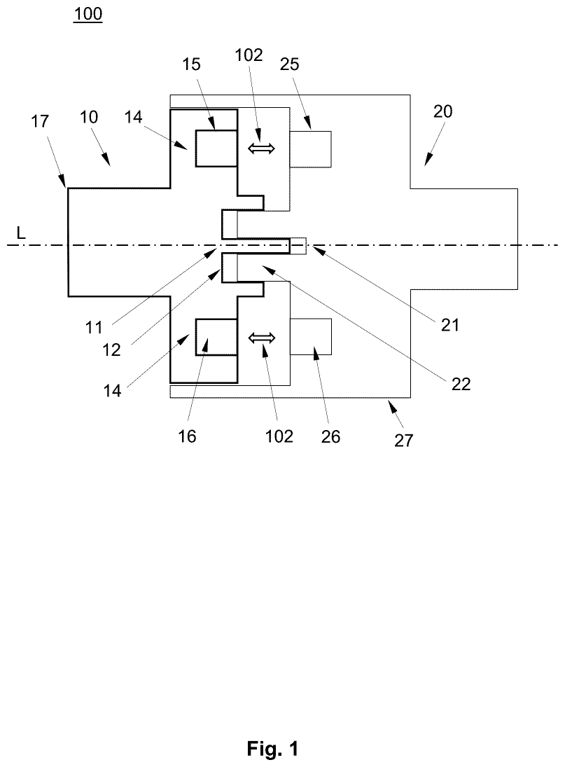

FIG. 1 shows a side view of a connector unit coupled to an additional connector unit according to a first aspect of the invention.

A connector unit 10 which can be detachably coupled to an additional connector unit 20 can be seen in FIG. 1. The connector unit 10 comprises an interface which, in the coupled arrangement, is opposite the interface of the additional connector unit 20.

The interface of the connector unit 10 comprises an energy transmission device 11. The energy transmission device 11 of the embodiment of FIG. 1 is formed by two contact-making sockets 12. The sockets 12 are designed such that the corresponding contact-making pins 22 of the energy transmission device 21 of the additional connector unit 20 can engage in the sockets in a form-fit. By coupling, the pins 22 of the additional connector unit are brought into engagement with the sockets 12 of the connector unit. The energy transmission devices 11; 21 are designed to transmit electrical energy between the connector unit 10 and the additional connector unit. In this respect, the energy transmission device 11 of the connector unit 10 can supply the other connector unit with power and vice versa.

Furthermore, the interface of the connector unit 10 in FIG. 1 comprises a signal transmitting and/or signal receiving device 14 which is designed to wirelessly transmit data between the connector unit 10 and a corresponding signal transmitting and/or signal receiving device 24 of the additional connector unit 20. The wireless data transmission 102 is indicated by the two double arrows in FIG. 1.

The signal transmitting and/or signal receiving device 14 of FIG. 1 comprises two signal receivers and/or transmitters 15; 16, wherein the first signal receiver and/or transmitter 15 can be suitable for transmitting high-resolution image data, and the second signal receiver and/or transmitter 16 can be suitable for transmitting control data. Likewise, a signal receiver and/or transmitter 15:16 can be provided which can transmit both high-resolution image data and control data simultaneously. The signal transmitting and/or signal receiving device 24 of the additional connector unit 20 can accordingly have two signal receivers and/or transmitters 25; 26, which receive control data or image data from, or send them to, the first and/or second signal receiver and/or transmitter 15; 16 of the connector unit 10.

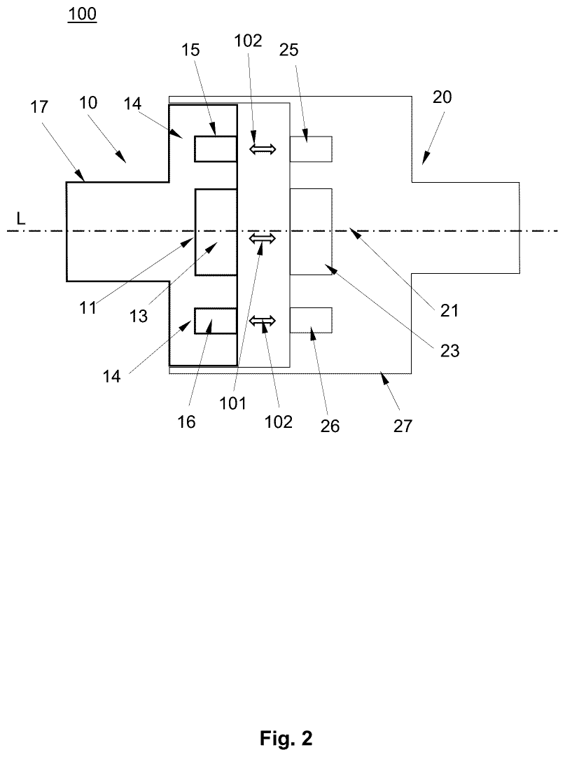

FIG. 2 shows a side view of a connector unit coupled to an additional connector unit according to a second aspect of the invention.

A second embodiment of the connector unit 10 can be seen, which can also be detachably coupled to an additional connector unit 20.

The second embodiment differs from the embodiment of FIG. 1 in particular in the design of the energy transmission device 11. The energy transmission device 11;21 in FIG. 2 does not have any poles or contact-making sockets or pins, but is based on the principle of inductive coupling 101. For this purpose, the energy transmission device 11 comprises a module 14 with an electrical coil in which an electrical current can be induced by the change in the magnetic flux through the energy transmission device 21 of the additional connector unit 20 in its near field. In this way, electrical energy can be transmitted from the energy transmission device 21 of the additional connector unit to the energy transmission device 11 of the connector unit 10. Accordingly, electrical energy can also be transmitted in the other direction, i.e. from the energy transmission device 11 of the connector unit 10 to the energy transmission device 21 of the additional connector unit 20, wherein the energy transmission device 21 comprises a corresponding module 24 with an electrical coil.

Both in the embodiment of FIG. 1 and in that of FIG. 2, the energy transmission device 11 can be arranged centered in the profile of the interface of the connector unit 10.

For the first embodiment, this arrangement has the advantage that the contact-making pins 22 according to FIG. 1 can be plugged into the particular sockets 12 of the connector unit 10 close to the longitudinal axis of the additional connector unit 20. In addition, the central region of the interface is best protected against dust or splash water when two connector units 10; 20 are coupled.

For the second embodiment, this arrangement has the advantage that the electromagnetic field for the inductive coupling 101 can be largely shielded.

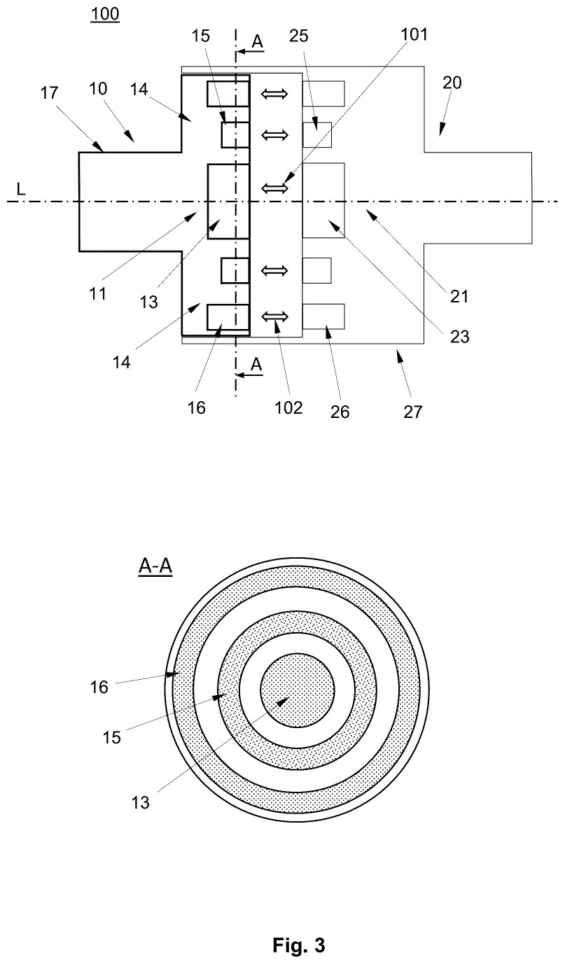

FIG. 3 shows a side view of a connector unit coupled to an additional connector unit according to a third aspect of the invention, as well as a sectional plane A-A through the connector unit.

The embodiment of the connector unit of FIG. 3 differs from the embodiment of the connector unit of FIG. 2 in the arrangement of the signal transmitting and/or signal receiving device. The signal transmitting and/or signal receiving device in FIG. 3 comprises a first signal receiver and/or transmitter 15 and a second signal receiver and/or transmitter 16, wherein both signal receivers and/or transmitters 15; 16 can be arranged substantially in concentric circles on the interface of the connector unit 10. This means that on the one hand, both connector units can be coupled to each other at any angle of rotation. On the other hand, one connector can be rotated around its longitudinal axis L relative to the other connector during ongoing operation. This makes it possible, for example, to provide a camera with such a connector so that the camera and the plug can be rotated in both directions.

The center of the concentric circles is established by the longitudinal axis of the connector unit 10. This embodiment has the advantage that the connector unit 10 is rotationally symmetrical, i.e. it can be coupled to an additional connector unit 20 in any position. Advantageously, the energy transmission device 11 is also arranged substantially round and centered in the interface of the connector unit 10, as can be seen in the sectional plane A-A of FIG. 3.

The connector unit 10 can be detachably coupled to an additional connector unit 20, as also shown in the view in FIGS. 1 to 3. In order to ensure that the coupling of two connector units 10, 20 is not inadvertently released during operation, for example when connecting additional movable components, a locking device can be provided on the housing 17 of the connector unit 10 or on the housing 27 of the additional connector unit 20 (not shown). This locking device can for example be a spring-loaded clamping device or a magnetic device.

By means of the device 100 or the plug-in system, a camera, in particular a camera that can be rotated 360°, can be connected to a trolley of a sewer inspection and/or maintenance system. The camera can be supplied with power via the energy transmission device 11 by means of inductive coupling 101. The camera can be controlled and its image data can be transmitted to a control unit of the trolley via the at least one, preferably bidirectional, wireless communication connection 102.

Likewise, an additional light can be connected to a trolley by means of the device 100.

Furthermore, a lift, in particular a telescopic lift, can be connected to a trolley by means of the device 100. The lift can be controlled by means of the wireless communication connection 102 and supplied with power through the inductive coupling 101.

A camera and/or an additional light can be connected to the lift by means of the device 100. As a result, the connector unit according to the invention allows for an easy-to-manufacture, low-maintenance and reliable modular extension of components of the sewer inspection and/or maintenance system.

Furthermore, a trolley can be connected to a cable drum by means of the device 100, wherein the cable drum can supply the trolley with power by means of the inductive coupling 101 and can transmit control data to the trolley or receive user data from the trolley, such as image data, by means of the at least one wireless communication connection. For this purpose, the cable drum can have a control unit.

We claim:

1. A connector unit for a component of a sewer inspection and/or maintenance system, wherein the connector unit comprises:
an energy transmission device for transmitting electrical energy between the connector unit and an additional connector unit, and
a signal transmitting and/or signal receiving device which is designed to wirelessly transmit data between the connector unit and the additional connector unit,
wherein the connector unit is detachably coupled to the additional connector unit.

2. The connector unit according to claim 1, wherein the energy transmission device comprises at least two contact-making sockets.

3. The connector unit according to claim 1, wherein the energy transmission device comprises at least two contact-making pins.

4. The connector unit according to claim 1, wherein the energy transmission device comprises a module adapted to transmit the electrical energy between the connector unit and the additional connector unit on an inductive basis.

5. The connector unit according to claim 1, wherein the connector unit is rotationally symmetrical about its longitudinal axis.

6. The connector unit according to claim 1, wherein the signal transmitting and/or signal receiving device comprises a first signal receiver and/or transmitter, wherein the first signal receiver and/or transmitter is adapted to wirelessly transmit high-resolution image data, sensor data and/or control data between the connector unit and the additional connector unit.

7. The connector unit according to claim 1, wherein the signal transmitting and/or signal receiving device comprises a second signal receiver and/or transmitter, wherein the second signal receiver and/or transmitter is adapted to wirelessly transmit image data, sensor data and/or control data between the connector unit and the additional connector unit.

8. The connector unit according to claim 1, wherein the connector unit comprises a housing.

9. The connector unit according to claim 8, wherein a locking device is arranged on the housing of the connector unit.

10. A device for coupling two components of a sewer cleaning and/or maintenance system, wherein the device comprises a first connector unit and a second connector unit, wherein the two connector units can be detachably coupled to one another, wherein the coupling of the two connector units comprises:
at least one wireless communication connection between the signal transmitting and/or signal receiving device of the first connector unit and the signal transmitting and/or signal receiving device of the second connector unit, and
an energy transmission connection between the energy transmission device of the first connector unit and the energy transmission device of the second connector unit.

11. The device according to claim 10, wherein the at least one wireless communication connection is bidirectional.

12. The device according to claim 10, wherein in the coupling of the two connector units, the particular energy transmission devices and signal transmitting and/or signal receiving devices are substantially sealed gas- and fluid-tight against the environment.
